(19) United States
(12) Patent Application Publication
(10) Pub. No.: US 2008/0002044 A1
(43) Pub. Date: Jan. 3, 2008

(54) Image pickup apparatus and amplification circuit

(75) Inventor: Tsuyoshi Higuchi, Kawasaki (JP)

Correspondence Address: ARENT FOX LLP, 1050 CONNECTICUT AVENUE, N.W., SUITE 400, WASHINGTON, DC, 20036, US

(73) Assignee: FUJITSU LIMITED

(21) Appl. No.: 11/543,796

(22) Filed: Oct. 6, 2006

(30) Foreign Application Priority Data
Jun. 30, 2006 (JP) 2006-180809

(51) Int. Cl. H04N 3/14; H04N 5/335

(52) U.S. Cl. 348/300

(57) ABSTRACT

A photoelectric conversion unit converts a received light into an electric signal. An amplification circuit amplifying the electric signal includes a plurality of elements of which a characteristic value is formed as the same value, an amplifier of which an amplification ratio is determined by a characteristic value of two composite elements constituted by connecting one or more of the elements, a changeover unit for changing over the element constituting each of the composite elements by changing over a connection between the elements, and an averaging unit for averaging outputs of the amplifier, which are obtained at every time of changing over the elements and making the average an output of the amplification circuit.

### CROSS REFERENCE TO RELATED APPLICATIONS

This application is based upon and claims the benefit of priority from the prior Japanese Patent Application No. 2006-180809, filed Jun. 30, 2006, the entire contents of which are incorporated by reference.

### BACKGROUND OF THE INVENTION

1. Field of the Invention

The present invention relates to an amplification technique for an electric signal and in particular to a technique, for equalizing an amplification factor, preferably applicable to an image pickup apparatus comprising an amplification circuit for an electric signal which is photo-electrically converted.

2. Description of the Related Art

Prior to an analog-digital (AD) conversion of an electric signal obtained by a photoelectric conversion of a received light, the electric signal for each of the pixels is amplified at a solid-state image pickup device. Conventionally popular for this purpose was a configuration to share an amplification circuit consisting of about one or two circuits for amplifying signals which are read from individual pixels. Such a configuration, however, is faced with a problem of overlapping noises in paths collecting pixel readout signals to the amplification circuits. Accordingly, a more recent solid-state image pickup device, in which a pixel readout signal level has been decreased by a reduction of a light reception area size per pixel unit in association with an increased number of pixels, no longer use such a configuration recently because a predefined signal to noise (S/N) ratio is difficult to secure. Instead, a configuration as described in the following is now widely used.

A first example of a configuration of such a solid-state image pickup device comprises an amplification circuit for each column of a pixel array and amplifies a pixel readout signal, followed by gathering the amplified readout signal to an AD converter. A second example of the configuration comprises an AD converter for each column of a pixel array and AD-converts the pixel readout signal directly (which is also called a column AD system, etcetera). Incidentally, some of the second example comprises an amplification circuit for each column of a pixel array, and amplifies a pixel readout signal first, followed by each of the AD converters AD-converting the amplified readout signal.

At this time, FIGS. 1A and 1B are described. These drawings exemplify configurations of an amplification circuit used also for the above noted solid-state image pickup device.

The circuit shown by FIG. 1A is a non-inversion amplification circuit with the input of Vin and the output of Vout.

In the circuit of FIG. 1A, a capacitor C1 is connected between the inverting input (i.e., the negative side input) of the operational amplifier and the output, and capacitors C2, C3 and C4 are parallelly inserted between the nodes (i.e., the node points), to which a reference voltage Vref is applied. Incidentally, the input Vin of the amplification circuit is applied to the non-inverting input (i.e., the positive side input) of the operational amplifier A, and the output of the operational amplifier A is the output Vout of the amplification circuit.

The amplification degree of the circuit shown by FIG. 1A is represented by the following expression:

$$\frac{Vout}{Vin} = 1 + \frac{C 2 + C 3 + C 4}{C 1} \qquad ( 1 )$$

Therefore, if the capacitance value of the capacitors C1, C2, C3 and C4 are the same (i.e., C1=C2=C3=C4), the amplification ratio of the circuit is four times.

Meanwhile, the circuit shown by FIG. 1B is an inverting amplification circuit with the input of Vin and the output of Vout.

In the circuit shown by FIG. 1B, a capacitor C1 is connected between the inverting input (i.e., the negative side input) of the operational amplifier A and the output, and capacitors C2, C3, C4 and C5 are parallelly inserted between the input Vin of the amplification circuit and the inverting input of the operational amplifier A. Incidentally, a reference voltage Vref is applied to the non-inverting input (i.e., the positive side input) of the operational amplifier A, and the output thereof is the output Vout of the amplification circuit.

The amplification degree of the circuit shown by FIG. 1B is represented by the following expression:

$$\frac{Vout}{Vin} = - \frac{C 2 + C 3 + C 4 + C 5}{C 1} \qquad ( 2 )$$

Therefore, if the capacitance value of the capacitors C1, C2, C3, C4 and C5 are the same (i.e., C1=C2=C3=C4=C5), the amplification ratio of the circuit is four times (with the polarity of the signal being reversed).

Incidentally, relating to the invention of the present patent application, a Laid-Open Japanese Patent Application Publication No. 2005-269471 has disclosed an invention relative to a readout circuit, being equipped for each column of a pixel array, which is configured to sample signals output from the pixel array for plural times and also add the sampled signals and output the result, thereby obtaining a good S/N characteristic and also enabling a control of an amplification ratio of the readout circuit by changing the number of sampling times.

Meanwhile, a Laid-Open Japanese Patent Application Publication No. 06-273230 has disclosed an invention for accumulating a component of a background light of an incident light, among a photoelectric current obtained by converting the incident light, in a capacity of a mathematical integrator, followed by accumulating the entirety of the photoelectric current in the capacity of the integrator and also subtracting the component of the aforementioned background light, thereby obtaining true optical information from the incident light, in an optical detection apparatus.

The amplification circuits shown by FIGS. 1A and 1B allow variations in the amplification ratios due to variations such as a capacitance value of a capacitor element, et cetera. Therefore, a use of these amplification circuits in a circuit configuration of the above described recent solid-state image pickup device, that is, a configuration comprising an amplification circuit for each column of a pixel array, allows a variation of amplification ratios for individual columns of the pixel array, possibly resulting in generating straight line stripes in the pickup image. A method is available for erasing such stripes by correcting at an image processing circuit at a later stage, which is a cause for making an image sensor larger and high cost in manufacturing because a correction circuit and memory element are required for such correction.

There has also been a proposal of a method for making each amplification circuit amplify a known reference signal and correcting an amplification ratio of each amplification circuit based on the result of the aforementioned amplification, thereby reducing a variation of the amplification ratios. However, an adequate correction is not always possible because of a measurement error of the amplification ratio or a limitation in a change of amplification ratios.

### SUMMARY OF THE INVENTION

The purpose of the present invention is to suppress a variation of an amplification ratio of an amplification circuit with a minimal increase of a circuit size.

According to one aspect of the present invention, an image pickup apparatus includes: a photoelectric conversion unit for converting a received light into an electric signal; and an amplification circuit for amplifying the electric signal, wherein the amplification circuit includes a plurality of elements of which a characteristic value is formed as the same value, an amplifier of which an amplification ratio is determined by a characteristic value of two composite elements constituted by connecting one or more of the elements, a changeover unit for changing over the element constituting each of the composite elements by changing over a connection between the elements, and an averaging unit for averaging outputs of the amplifier which are obtained at every time of changing over the elements and making the average an output of the amplification circuit.

This configuration makes the average of outputs of the amplifier, as the output of the amplification circuit, which are obtained at every time of changing over a plurality of elements, even if there are variations among these elements of which the characteristic is lined up to the same value, thereby averaging out the output of the amplification circuit. As a result, the problem of the occurrence of stripes as described above is prevented in the pickup image.

The image pickup apparatus according to the present invention may also be configured so that the plurality of elements is a capacitor.

This configuration makes it possible to reduce power consumption and minimize an area size occupied by the amplifier on a semiconductor circuit board when configuring an amplification circuit as an integrated circuit.

Another related configuration may be such as to further comprise an initialization process unit for shorting between terminals of the capacitors for initialization.

This configuration makes it possible to eliminate an influence of a charge remaining in the capacitors on an amplification operation of the amplifier.

The image pickup apparatus according to the present invention may also be configured so that the plurality of elements is a resistor.

This configuration makes it possible to eliminate an initialization process otherwise required in the case of using the capacitor as the aforementioned element, hence making an operation control for the circuit easy.

The image pickup apparatus according to the present invention may also be configured so that the amplifier is an inverting amplifier using an operational amplifier.

This configuration enables a high speed operation of the amplifier and also the amplifier to be hardly influenced by parasitic capacitance.

The image pickup apparatus according to the present invention may also be configured so that the amplifier is a non-inverting amplifier using an operational amplifier.

This configuration reduces the number of the aforementioned elements necessary for obtaining the same amplification ratio as compared to the case of using an inverting amplifier.

The image pickup apparatus according to the present invention may also be configured so that the averaging unit includes a plurality of capacitors for accumulating outputs of the amplifier.

This configuration makes it possible to once accumulate, in the aforementioned capacitors, outputs of the amplifier which are obtained at every time of changing over elements, followed later by averaging them out for making it an output of the amplification circuit.

Another related configuration may be so as to further include an initialization process unit for shorting between terminals of the capacitors for initialization.

This configuration makes it possible to eliminate an influence of a charge remaining in the capacitors on an amplification operation of the amplifier.

Another related configuration may be so as to further include an analog-digital (AD) converter for converting an output of the amplification circuit into digital data, wherein the capacitor is a sample hold capacitor for retaining an output of the amplification circuit on an input side of the AD converter for a predefined period of time.

This configuration allows a common use of a capacitor of the averaging unit as a sample hold capacitor, thereby eliminating a dedicated-use sample hold capacitor.

The image pickup apparatus according to the present invention may also be configured to further include a changeover control unit for controlling an interval of changing over a connection between the elements by the changeover unit based on an intensity of light received at the photoelectric conversion unit.

This configuration enables an image pickup of a dark object brightly.

According to one of another aspect of the present invention, an amplification circuit includes: a plurality of elements of which a characteristic value is formed as the same value, an amplifier of which an amplification ratio is determined by a characteristic value of two composite elements constituted by connecting one or more of the elements, a changeover unit for changing over the element constituting each of the composite elements by changing over a connection between the elements, and an averaging unit for averaging outputs of the amplifier which are obtained at every time of changing over the elements.

This configuration makes the average of outputs of the amplifier, as the output of the amplification circuit, which are obtained at every time of changing over a plurality of elements, even if there are variations among these elements of which the characteristic is lined up to the same value, thereby averaging out the output of the amplification circuit.

The present invention is contrived in such a manner as described above, thereby providing a benefit of effectively suppressing a variation of an amplification ratio of an amplification circuit with a minimal increase of the circuit size.

### BRIEF DESCRIPTION OF THE DRAWINGS

The present invention will be more apparent from the following detailed description when the accompanying drawings are referred to.

FIG. 1A is a diagram showing a first example configuration of a conventional amplification circuit;

FIG. 1B is a diagram showing a second example configuration of a conventional amplification circuit;

FIG. 2A is a diagram showing a configuration of a first example of a solid-state image pickup device which is an image pickup apparatus embodying the present invention;

FIG. 2B is a diagram showing a configuration of a second example of a solid-state image pickup device which is an image pickup apparatus embodying the present invention;

FIG. 3A is a diagram showing a first example of a configuration of an amplification circuit embodying the present invention;

FIG. 3B is a diagram showing a changeover control operation of individual switches used for the amplification circuit shown by FIG. 3A;

FIG. 4A is a diagram showing a second example of a configuration of an amplification circuit embodying the present invention;

FIG. 4B is a diagram showing a changeover control operation of individual switches used for the amplification circuit shown by FIG. 4A;

FIG. 5A is a diagram showing a third example of a configuration of an amplification circuit embodying the present invention;

FIG. 5B is a diagram showing a changeover control operation of individual switches used for the amplification circuit shown by FIG. 5A;

FIG. 6A is a diagram showing a fourth example of a configuration of an amplification circuit embodying the present invention; and

FIG. 6B is a diagram showing a changeover control operation of individual switches used for the amplification circuit shown by FIG. 6A.

### DESCRIPTION OF THE PREFERRED EMBODIMENTS

The following is a description of the preferred embodiment of the present invention based on the accompanying drawings.

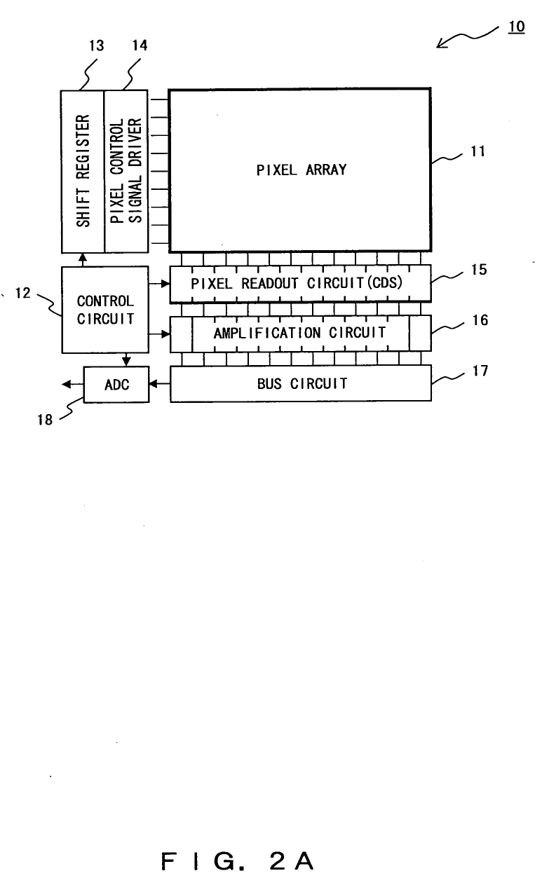

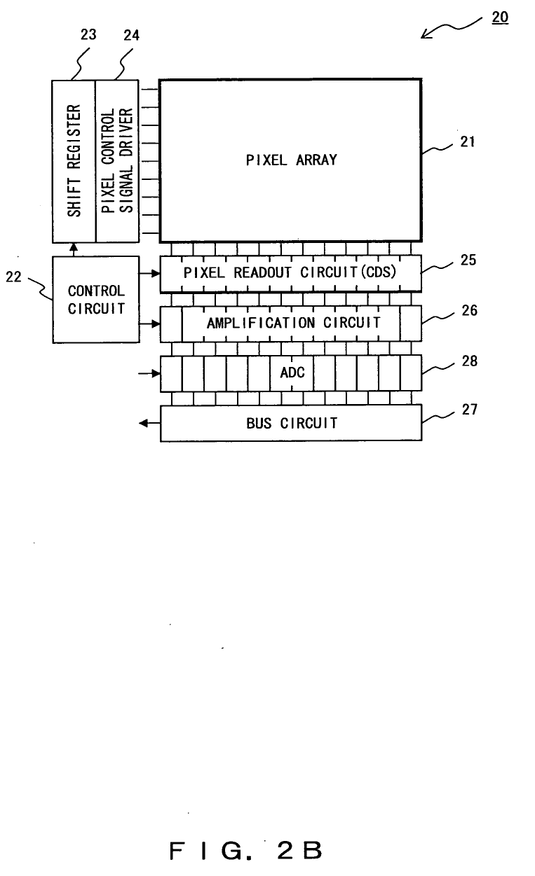

The first description is of FIGS. 2A and 2B, each of which shows a configuration of a solid-state image pickup device that is an image pickup apparatus embodying the present invention.

The first is to describe the first example of the solid-state image pickup device shown by FIG. 2A.

In the solid-state image pickup device 10, a pixel array 11 converts a light received on an image pickup plane photo-electrically and generates a signal charge in proportion to an intensity of the aforementioned light.

A control circuit 12 performs an operation control by providing each constituent component of the solid-state image pickup device 10 with a predetermined pulse signal.

A shift register 13 generates a control signal for a transfer of charge within the pixel array 11 from a pulse signal transmitted from the control circuit 12. The control signal is amplified by a pixel control signal driver 14 and input to the pixel array 11.

A signal charge read out from each column of the pixel array 11 according to the control signal is input to a pixel readout circuit 15 which then outputs an electric signal of a voltage corresponding to the signal charge volume by each of the pixel arrays 11. Note that the pixel readout circuit 15 includes a Correlated Double Sampling (CDS) circuit and also removes a noise.

An amplification circuit 16 comprises a later described circuit configuration for each column of the pixel array 11 and outputs, to a bus circuit 17, an electric signal transmitted from the pixel readout circuit 15 by amplifying it.

The bus circuit 17 gathers signals of the respective columns of the pixel array 11 which are output from the amplification circuit 16 to an analog-digital converter (ADC) 18.

The ADC 18 analog-digital (AD)-converts the collected signals sequentially and makes digital data corresponding to the signal voltage as an output of the solid-state image pickup device 10.

The next description is of a second example of the solid-state image pickup device shown by FIG. 2B.

Referring to the solid-state image pickup device 20 shown by FIG. 2B, a pixel array 21, a control circuit 22, a shift register 23, a pixel control signal driver 24 and a pixel readout circuit 25 are the same as the pixel array 11, control circuit 12, shift register 13, pixel control signal driver 14 and pixel readout circuit 15, respectively, of the solid-state image pickup device 10 shown by FIG. 2A.

An amplification circuit 26 comprises a later described circuit configuration for each column of the pixel array 21 and outputs, to an ADC 28, an electric signal transmitted from the pixel readout circuit 25 by amplifying it.

The ADC 28 AD-converts a signal output from the amplification circuit 26 per each column of the pixel array 21 and outputs digital data corresponding to the signal voltage to a bus circuit 27.

The bus circuit 27 arranges, in a predefined sequence, respective digital data from individual columns of the pixel array 21 which are output from the ADC 28 and makes them an output of the solid-state image pickup device 20.

The next description is of a configuration of an amplification circuit embodying the present invention. Note that each configuration example of an amplification circuit described in the following can be used as the amplification circuit 16 comprised by the solid-state image pickup device 10 shown by FIG. 2A, or as the amplification circuit 26 comprised by the solid-state image pickup device shown by FIG. 2B.

Note that a comprisal of a switch, which is a constituent component of an amplification circuit for example, by a transistor circuit, thus forming all constituent components of each amplification circuit, which are described in the following, on a single semiconductor circuit board, thereby making it possible to configure the amplification circuit as an integrated circuit. It is of course possible to also include the amplification circuit on a semiconductor circuit board on which a solid-state image pickup device is featured.

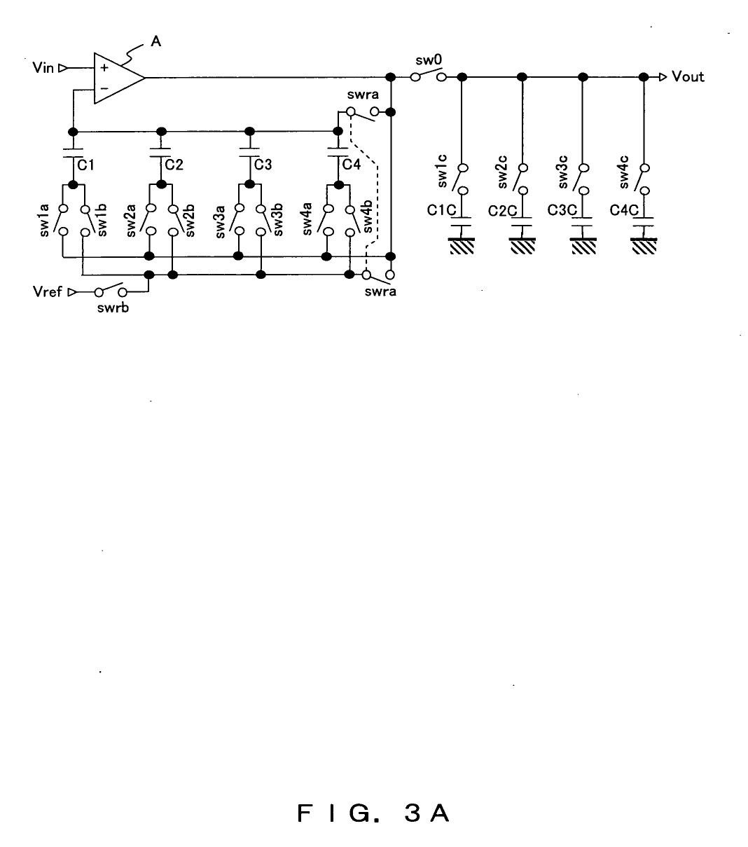

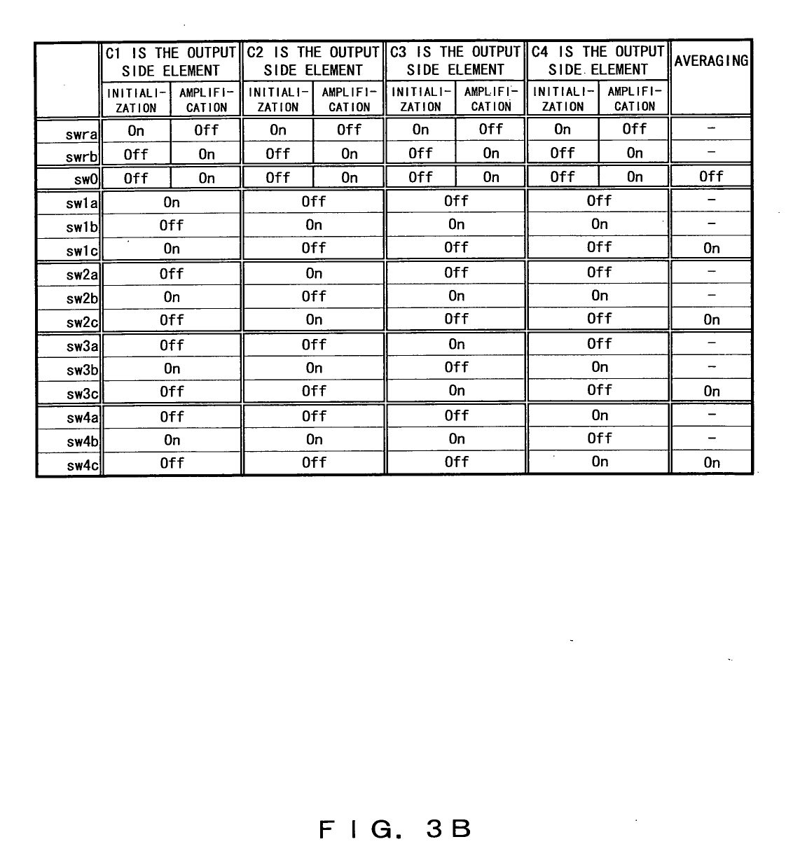

First, a description is of FIG. 3A which shows a first example of a configuration of an amplification circuit embodying the present invention.

The amplification circuit shown by FIG. 3A comprises an operational amplifier A, capacitors C1, C2, C3, C4, C1C, C2C, C3C and C4C, and switches sw1a, sw1b, sw1c, sw2a, sw2b, sw2c, sw3a, sw3b, sw3c, sw4a, sw4b, sw4c, swra, swrb, and sw0. Here, the capacitors C1, C2, C3 and C4 are configured to have the same characteristic value (i.e., the capacitance value), and so are the capacitors C1C, C2C, C3C and C4C configured to have the same capacitance value.

The switches sw1a, sw1b, sw1c, sw2a, sw2b, sw2c, sw3a, sw3b, sw3c, sw4a, sw4b, sw4c, swra, swrb, and sw0 are all dual contact switches comprising a make contact and a common contact, with the switch swra being a dual circuit interlock switch and other switches being single circuit switches.

In one circuit of the switch swra, the make contact is connected to the output of the operational amplifier A, and the common contact is connected to the inverting input thereof. In the other circuit of the switch swra, the make contact is connected to the output of the operational amplifier A, and the common contact is connected to the respective common contacts of the switches sw1b, sw2b, sw3b, sw4b and swrb. And the respective make contacts of the switches sw1a, sw2a, sw3a and sw4a are also connected to the output of the operational amplifier A.

The capacitor C1 is inserted between the inverting input of the operational amplifier A and the connection point of the respective common contacts of the switches sw1a and sw1b, while the capacitor C2 is inserted between the inverting input of the operational amplifier A and the connection point of the respective common contacts of the switches sw2a and sw2b. The capacitor C3 is inserted between the inverting input of the operational amplifier A and the connection point of the respective common contacts of the switches sw3a and sw3b, while the capacitor C4 is inserted between the inverting input of the operational amplifier A and the connection point of the respective common contacts of the switches sw4a and sw4b. And the capacitors C1C, C2C, C3C and C4C are inserted between the respective make contacts of the switches sw1c, sw2c, sw3c and sw4c and the ground (i.e., a reference ground potential).

The output of the operational amplifier A is also connected to the common contact of the switch sw0. The make contact of the switch sw0 is connected to the respective common contacts of the switches sw1c, sw2c, sw3c and sw4c, thus the connection point being the output Vout of the amplification circuit shown by FIG. 2A. Note that the input Vin of the amplification circuit is applied to the non-inverting input of the operational amplifier A. And a reference voltage Vref is applied to the common contact of the switch swrb.

The next description is of an operation of the amplification circuit by using the table shown by FIG. 3B.

The table of FIG. 3B shows a changeover control operation of each switch used in the amplification circuit shown by FIG. 3A. Note that, if the amplification circuit shown by FIG. 3A is used as the amplification circuit 16 comprised by the solid-state image pickup device 10 shown by FIG. 2A, the control operation is carried out by the control circuit 12, while if it is used as the amplification circuit 26 comprised by the solid-state image pickup device 20 shown by FIG. 2B, the control operation is carried out by the control circuit 22.

Referring to the table of FIG. 3B, each row shows a state of each switch constituting the amplification circuit of FIG. 3A. Here, the word “On” shown in each field means that the common contact is contacted to the make contact of the switch corresponding to the row including the field, thereby shorting the both contacts. Comparably, the word “Off” means that the common contact is separated from the make contact of the switch corresponding to the row including the field, thereby opening the both contacts.

First, the control operation refers to the left end column “C1 is the output side terminal” in the table of FIG. 3B and carries out the control of changing over each switch so as to make the state indicated by the word of each field of the column. In this event, however, the switches swra, swrb and sw0 are changed over to the states indicated by the word of each field of the column “initialization” within the present column. A changeover of the switches swra, swrb and sw0 to the state shorts between the respective terminals of the capacitors C1, C2, C3 and C4 for initialization, making the accumulated charge reduced to zero.

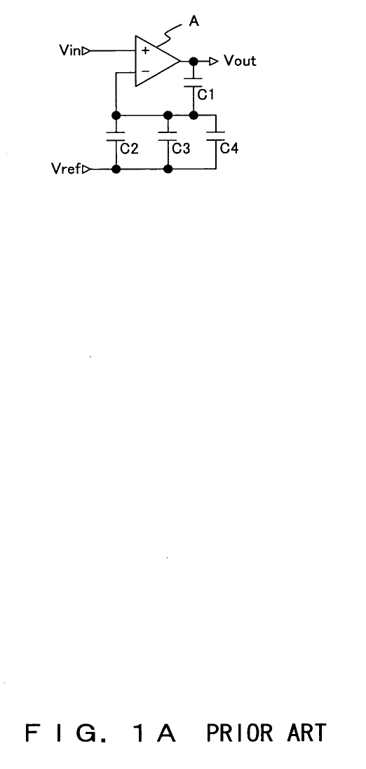

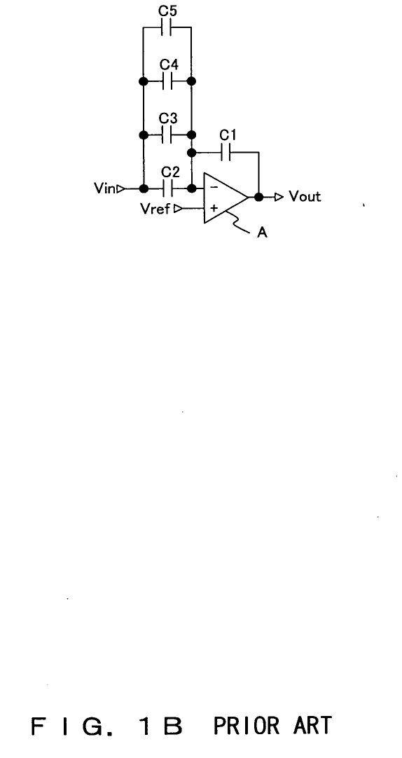

Then, following the initialization process, the control operation changes over the respective states of the switches swra, swrb and sw0 to the states indicated by the words of individual fields of the column “Amplification” within the column “C1 is the output side terminal”. Then, the connection relationship between the operational amplifier A and capacitors C1, C2, C3 and C4 becomes the same as the non-inverting amplifier shown in FIG. 1A. Therefore, the output (i.e., the output of the non-inverting amplifier) V1 of the operational amplifier A in this event is represented by the following expression:

$$V 1 = ( 1 + \frac{C 2 + C 3 + C 4}{C 1} ) Vin = ( \frac{C 1 + C 2 + C 3 + C 4}{C 1} ) Vin \qquad ( 3 )$$

From the above noted expression (3), it is apparent that an amplification ratio of the non-inverting amplifier in this event is determined by the capacitance of the capacitor C1 and that of a composite capacitor configured by parallelly connecting capacitors C2, C3 and C4.

The capacitor C1C accumulates charge by being applied by the voltage V1.

Then the control operation refers to the column “C2 is the output side terminal” in the table of FIG. 3B and carries out a control of changing over each switch so as to make the state indicated by the word of each field of the column. However, the switches swra, swrb and sw0 are first changed over to the states indicated by the word of each field of the column “initialization” within the present column, thereby initializing the capacitors C1, C2, C3 and C4, followed by changing over to the state indicated by the word of each field of the column “Amplification” for an amplification operation. In this event, the output V2 of the operational amplifier is represented by the following expression:

$$V 2 = ( 1 + \frac{C 3 + C 4 + C 1}{C 2} ) Vin = ( \frac{C 1 + C 2 + C 3 + C 4}{C 2} ) Vin \qquad ( 4 )$$

From the above noted expression (4), it is apparent that an amplification ratio of the non-inverting amplifier in this event is determined by the capacitance of the capacitor C2 and that of a composite capacitor configured by parallelly connecting capacitors C3, C4 and C1.

The capacitor C2C accumulates charge by being applied by the voltage V2.

Then, the control operation likewise carries out a control of changing over each switch so as to make the state indicated by the word of each field of the column “C3 is the output side terminal” in the table of FIG. 3B, thereby initializing the capacitors C1, C2, C3 and C4 and carrying out an amplification operation. In this event, the output V3 of the operational amplifier is represented by the following expression:

$$V 3 = ( 1 + \frac{C 4 + C 1 + C 2}{C 3} ) Vin = ( \frac{C 1 + C 2 + C 3 + C 4}{C 3} ) Vin \qquad ( 5 )$$

From the above noted expression (5), it is apparent that an amplification ratio of the non-inverting amplifier in this event is determined by the capacitance of the capacitor C3 and that of a composite capacitor configured by parallelly connecting capacitors C4, C1 and C2.

The capacitor C3C accumulates charge by being applied by the voltage V3.

Next, the control operation likewise carries out a control of changing over each switch so as to make the state indicated by the word of each field of the column “C4 is the output side terminal” in the table of FIG. 3B, thereby initializing the capacitors C1, C2, C3 and C4 and carrying out an amplification operation. In this event, the output V4 of the operational amplifier is represented by the following expression:

$$V 4 = ( 1 + \frac{C 1 + C 2 + C 3}{C 4} ) Vin = ( \frac{C 1 + C 2 + C 3 + C 4}{C 4} ) Vin \qquad ( 6 )$$

From the above noted expression (6), it is apparent that an amplification ratio of the non-inverting amplifier in this event is determined by the capacitance of the capacitor C4 and that of a composite capacitor configured by parallelly connecting capacitors C1, C2 and C3.

As described above, the organization of capacitors determining the amplification of the non-inverting amplifier are changed over by the switches sw1a, sw1b, sw2a, sw2b, sw3a, sw3b, sw4a and sw4b changing over the interconnection of the capacitors C1, C2, C3 and C4.

Next, the control operation carries out a control of changing over each switch so as to make the state indicated by the word in each field of the column “Averaging” on the right end of the table shown by FIG. 3B. Here, the sign−indicated in the respective fields means that the switch corresponding to the row including the field may be in either state of being “shorted” or “open”.

As all of the switches sw1c, sw2c, sw3c and sw4c becomes the shorted state by each of the switches being changed over as indicated in the respective fields of the aforementioned column “Averaging”, the capacitors C1C, C2C, C3C and C4C are parallelly connected. Here, if the capacitors C1C, C2C, C3C and C4C have the same capacitance, the output Vout of the amplification circuit shown by FIG. 3A is represented by the following expression:

$$Vout = \frac{V 1 + V 2 + V 3 + V 4}{4} = \frac{1}{4} ( C 1 + C 2 + C 3 + C 4 ) ( \frac{1}{C 1} + \frac{1}{C 2} + \frac{1}{C 3} + \frac{1}{C 4} ) Vin \qquad ( 7 )$$

That is, a parallel connection of the capacitors C1C, C2C, C3C and C4C averages out the outputs of the non-inverting amplifier, which has been obtained at every changeover of the organization of the capacitors.

Here, if C1=C2=C3=C4, the amplification ratio of the amplification circuit is four times according to the above noted expression (7). It is also apparent that the amplification ratio of the amplification circuit of FIG. 3A is averaged out even if the capacitance values of the capacitors C1, C2, C3 and C4, which are so formed as to have the same capacitance value, have variations when the symmetry of C1, C2, C3 and C4 in the above noted expression (7) is focused. Therefore a variation in the amplification ratio is suppressed.

Note that the variations of the capacitors C1C, C2C, C3C and C4C, which are so formed as to have the same capacitance value, cause a very little influence on the effect of suppressing a variation of the amplification ratio of the amplification circuit shown by FIG. 3A.

The ADC 18 comprised by the solid-state image pickup device 10 shown by FIG. 2A, and the ADC 28 comprised by the solid-state image pickup device 20 shown by FIG. 2B AD-converts the present output Vout of the amplification circuit. Therefore, a composite capacitor formed by the parallel connection of the capacitors C1C, C2C, C3C and C4C in this event can be substituted for a sample hold capacitor for retaining an output of the amplification circuit 16 or 26 on the input side of the ADC 18 or 28 for a predefined period of time. That is, a use of the amplification circuit shown by FIG. 3A for the solid-state image pickup device 10 shown by FIG. 2A or for the solid-state image pickup device 20 shown by FIG. 2B eliminates a necessity of equipping a specific use sample hold capacitor on the ADC 18 or 28.

The subsequent changeover control operations for each switch of FIG. 3A are carried out according to the table of FIG. 3B, thereby the control operation being repeated sequentially from the left end column to the right end column.

Note that changeover of each switch in the changeover control operation is carried out according to a cycle of pulse signals output from the control circuit 12 or 22, e.g., in a predetermined fixed interval. A change of changeover interval, however, makes it possible to change an overall sensitivity of an optical detection at the solid-state image pickup device 10 or 20. Therefore, a configuration may be in a manner to have the control circuit 12 or 22 itself or an external arithmetic operation apparatus calculate an average of data worth one pixel, which is output by each pixel from the ADC 18 or 28, and to have the control circuit 12 or 22 control the interval of the output pulse signals based on the average value. Such a configuration in which the control circuit 12 or 22 controls a changeover interval of each switch so as to lengthen the interval, if an optical intensity is low, as compared to a case of the aforementioned optical intensity being high, based on the optical intensity of the received light on the image pickup plane of the pixel array 11 or 21, thereby enabling the solid-state image pickup device 10 or 20 to pick up a bright image of a dark object.

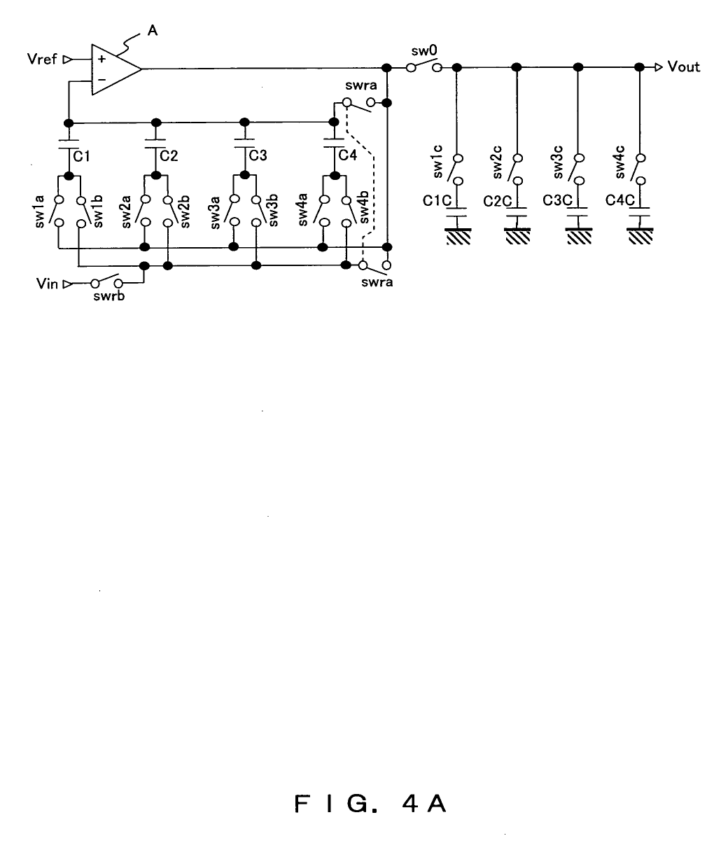

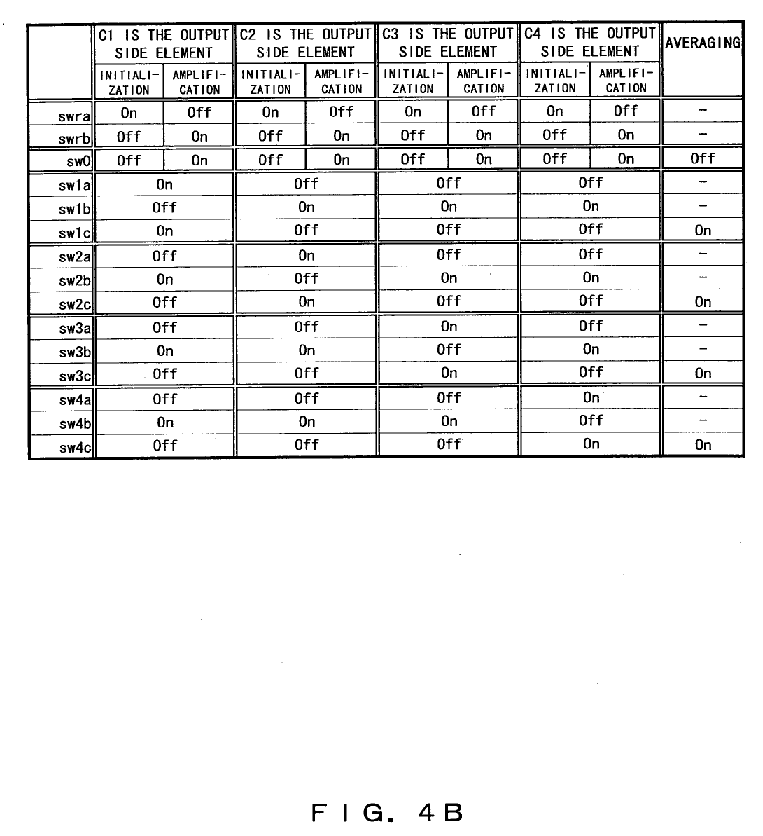

The next description is of FIG. 4A which shows a second example of a configuration of an amplification circuit embodying the present invention.

The amplification circuit shown by FIG. 4A comprises an operational amplifier A, capacitors C1, C2, C3, C4, C1C, C2C, C3C and C4C, and switches sw1a, sw1b, sw1c, sw2a, sw2b, sw2c, sw3a, sw3b, sw3c, sw4a, sw4b, sw4c, swra, swrb, and sw0. Here, the capacitors C1, C2, C3 and C4 are configured to have the same characteristic value (i.e., the capacitance value), and so are the capacitors C1C, C2C, C3C and C4C configured to have the same capacitance value.

The amplification circuit shown by FIG. 4A is configured in the same manner as the amplification circuit shown by FIG. 3A except for applying a reference voltage Vref, in lieu of the input Vin of the amplification circuit, to the non-inverting input of the operational amplifier A, and applying the input Vin of the amplification circuit, in lieu of the reference voltage Vref, to the common contact of the switch swrb.

The next description is of an operation of the amplification circuit shown by FIG. 4A by referring to the table shown by FIG. 4B.

The table shown by FIG. 4B shows a changeover control operation of individual switches used for the amplification circuit shown by FIG. 4A. Note that, if the amplification circuit shown by FIG. 4A is used as the amplification circuit 16 comprised by the solid-state image pickup device 10 shown by FIG. 2A, the control operation is carried out by the control circuit 12, while if it is used as the amplification circuit 26 comprised by the solid-state image pickup device 20 shown by FIG. 2B, the control operation is carried out by the control circuit 22.

Incidentally, the words “On” and “Off” and the sign “−” which are indicated in the respective field of the table shown by FIG. 4B mean the same as ones shown in the table of FIG. 3B.

The control operation first performs a control of changing over respective switches so as to make the state indicated by the word in each field of the column “C1 is the output side element” of the table of FIG. 4B, thereby initializing the capacitors C1, C2, C3 and C4 and carrying out an amplification operation in the same manner as the control operation for the amplification circuit of FIG. 3A as indicated by the table of FIG. 3B. The output (i.e., the output of the inverting amplifier) V1 of the operational amplifier A in this event is represented by the following expression:

$$V 1 = ( \frac{C 2 + C 3 + C 4}{C 1} ) Vin = - ( \frac{C 1 + C 2 + C 3 + C 4}{C 1} - 1 ) Vin \qquad ( 8 )$$

Next, the control operation likewise carries out a control of changing over each switch so as to make the state indicated by the word of each field of the column “C2 is the output side element” of the table of FIG. 4B, thereby initializing the capacitors C1, C2, C3 and C4 and carrying out an amplification operation. The output V2 of the operational amplifier A in this event is represented by the following expression:

$$V 2 = ( \frac{C 3 + C 4 + C 1}{C 2} ) Vin = - ( \frac{C 1 + C 2 + C 3 + C 4}{C 2} - 1 ) Vin \qquad ( 9 )$$

Then, the control operation likewise carries out respective controls of changing over each switch so as to make the states indicated by the word of each field of the columns “C3 is the output side element” and “C4 is the output side element”, respectively, of the table of FIG. 4B, thereby initializing the capacitors C1, C2, C3 and C4 and carrying out the amplification operations sequentially. The respective outputs V3 and V4 of the operational amplifier A are represented by the following expressions:

$$\begin{matrix}V 3 = ( \frac{C 4 + C 1 + C 2}{C 3} ) Vin = - ( \frac{C 1 + C 2 + C 3 + C 4}{C 3} - 1 ) Vin & ( 10 ) \\ V 4 = ( \frac{C 1 + C 2 + C 3}{C 4} ) Vin = - ( \frac{C 1 + C 2 + C 3 + C 4}{C 4} - 1 ) Vin & ( 11 )\end{matrix}$$

Then, the control operation carries out a control of changing over each switch so as to make the state indicated by the word in each field of the column “Averaging” on the right end of the table shown by FIG. 4B. As all of the switches sw1c, sw2c, sw3c and sw4c becomes the shorted state by each of the switches being changed over as indicated in the respective fields of the aforementioned column “Averaging”, the capacitors C1C, C2C, C3C and C4C are parallelly connected. Here, if the capacitors C1C, C2C, C3C and C4C have the same capacitance, the output Vout of the amplification circuit shown by FIG. 4A is represented by the following expression:

$$Vout = \frac{V 1 + V 2 + V 3 + V 4}{4} = - \frac{1}{4} \{ ( C 1 + C 2 + C 3 + C 4 ) ( \frac{1}{C 1} + \frac{1}{C 2} + \frac{1}{C 3} + \frac{1}{C 4} ) - 4 \} Vin \qquad ( 12 )$$

That is, a parallel connection of the capacitors C1C, C2C, C3C and C4C averages out the outputs of the inverting amplifier, which has been obtained at every changeover of the organization of the capacitors.

Here, if C1=C2=C3=C4, the amplification ratio of the amplification circuit is three times according to the above noted expression (12). It is also apparent that the amplification ratio of the amplification circuit of FIG. 4A is averaged out even if the capacitance values of the capacitors C1, C2, C3 and C4, which are so formed as to have the same capacitance value, have variations when the symmetry of C1, C2, C3 and C4 in the above noted expression (12) is focused. Therefore a variation in the amplification ratio is suppressed.

The amplification circuit of FIG. 4A comprises an inverting amplifier, hence having the advantage of a high speed operation and a very little influence by a parasitic capacitance, although the circuit needs one more capacitor for obtaining the same amplification ratio as compared to the amplification circuit shown by FIG. 3A which comprises a non-inverting amplifier.

Note that the variations of the capacitors C1C, C2C, C3C and C4C which are so formed as to have the same capacitance value cause a very little influence on the effect of suppressing a variation of the amplification ratio of the amplification circuit shown by FIG. 4A in the same manner as the amplification circuit shown by FIG. 3A.

Also, the same as the amplification circuit shown by FIG. 3A, a use of the amplification circuit shown by FIG. 4A for the solid-state image pickup device 10 shown by FIG. 2A or for the solid-state image pickup device 20 shown by FIG. 2B eliminates a necessity of equipping a specific use sample hold capacitor on the ADC 18 or 28.

Furthermore, in the case of using the amplification circuit shown by FIG. 4A for the solid-state image pickup device 10 shown by FIG. 2A or for the solid-state image pickup device 20 shown by FIG. 2B, the control circuit 12 or 22 controls a changeover interval of each switch so as to lengthen the interval, if an optical intensity is low, as compared to a case of the aforementioned optical intensity being high, based on the optical intensity of the received light on the image pickup plane of the pixel array 11 or 21, thereby enabling the solid-state image pickup device 10 or 20 to pick up a bright image of a dark object, the same as the amplification circuit shown by FIG. 3A.

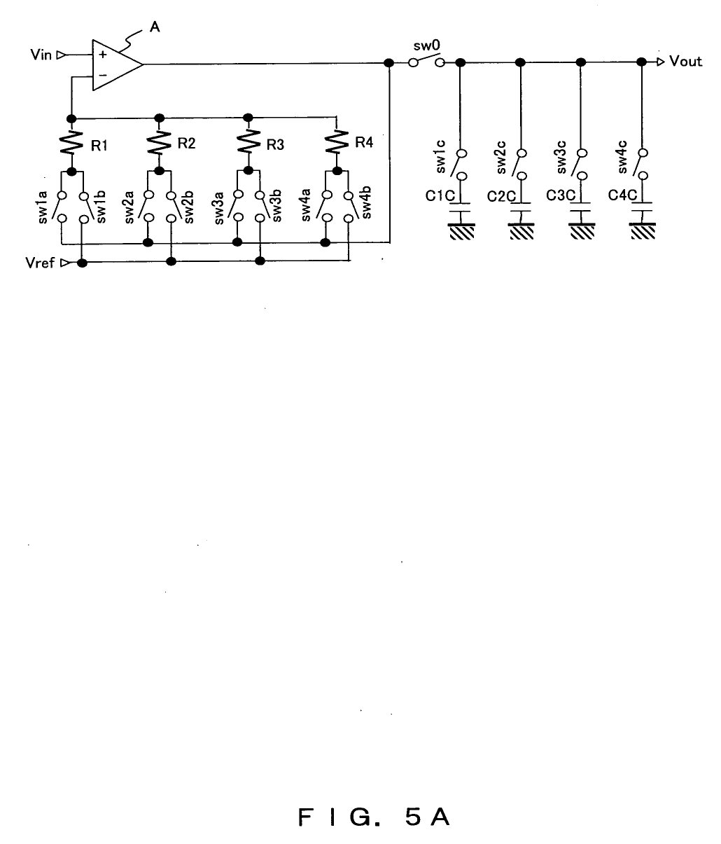

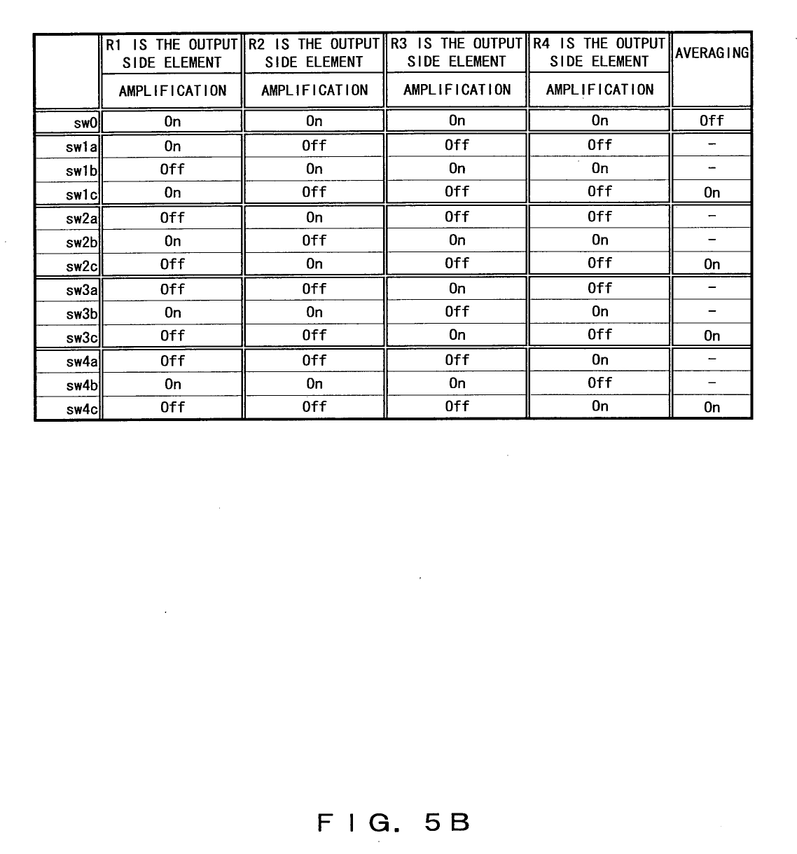

The next description is of FIG. 5A which shows a third example of a configuration of an amplification circuit embodying the present invention.

The amplification circuit shown by FIG. 5A comprises an operational amplifier A, resistors R1, R2, R3 and R4, capacitors C1C, C2C, C3C and C4C, switches sw1a, sw1b, sw1c, sw2a, sw2b, sw2c, sw3a, sw3b, sw3c, sw4a, sw4b, sw4c, and sw0. Here, the resistors R1, R2, R3 and R4 are configured to have the same characteristic value (i.e., the resistance value), and so are the capacitors C1C, C2C, C3C and C4C configured to have the same capacitance value.

The amplification circuit shown by FIG. 5A is configured in the same manner as the amplification circuit shown by FIG. 3A except for replacing the capacitors C1, C2, C3 and C4 with the resistors R1, R2, R3 and R4, eliminating the switch swra, which is a dual circuit interlock switch, by making both circuits the state of normal open and eliminating the switch swrb by making it the state of being normally shorted.

The next description is of the amplification circuit shown by FIG. 5A by referring to a table shown by FIG. 5B.

The table of FIG. 5B shows a changeover operation control for each switch used for the amplification circuit shown by FIG. 5A. Note that, if the amplification circuit shown by FIG. 5A is used as the amplification circuit 16 comprised by the solid-state image pickup device 10 shown by FIG. 2A, the control operation is carried out by the control circuit 12, while if it is used as the amplification circuit 26 comprised by the solid-state image pickup device 20 shown by FIG. 2B, the control operation is carried out by the control circuit 22.

Incidentally, the words “On” and “Off” and the sign “−” which are indicated in the respective field of the table shown by FIG. 5B mean the same as ones shown in the table of FIG. 3B.

The table in FIG. 5B is the same as the table in FIG. 3B except for replacing “C1”, “C2”, “C3” and “C4” with “R1”, “R2”, “R3” and “R4”, respectively, and for a column “Initialization” being nonexistent. That is, the circuit of FIG. 5A does not use a capacitor needing an initialization, thus eliminating an initialization process which is required for the circuit shown by FIG. 3A.

With the exception of not performing an initialization process, the changeover operation for each switch in the circuit of FIG. 5A is the same as in the circuit shown by FIG. 3A. That is, the switches sw1a, sw1b, sw2a, sw2b, sw3a, sw3b, sw4a and sw4b change over the interconnection of the resistors R1, R2, R3 and R4, thereby changing over the organization of the resistors determining an amplification ratio of the non-inverting amplifier.

The outputs of the operational amplifier A at the time of changing over individual switches are the above noted expressions (3), (4), (5) and (6) with “C1”, “C2”, “C3” and “C4” being replaced by “R1”, “R2”, “R3” and “R4”, respectively. Therefore, the output Vout of the amplification circuit shown by FIG. 5A at the time of controlling for changing over each switch so as to make the state indicated by the word in each field of the column “Averaging” on the right end of the table in FIG. 5B is represented by the following expression if the capacitors C1C, C2C, C3C and C4C have the same capacitance:

$$Vout = \frac{1}{4} ( R 1 + R 2 + R 3 + R 4 ) ( \frac{1}{R 1} + \frac{1}{R 2} + \frac{1}{R 3} + \frac{1}{R 4} ) Vin \qquad ( 13 )$$

That is, a parallel connection of the capacitors C1C, C2C, C3C and C4C averages out the outputs of the non-inverting amplifier in this event, which has been obtained at every changeover of the organization of the capacitors.

Here, if R1=R2=R3=R4, the amplification ratio of the amplification circuit is four times according to the above noted expression (13). It is also apparent that the amplification ratio of the amplification circuit of FIG. 5A is averaged out even if the resistance values of the resistors R1, R2, R3 and R4, which are so formed as to have the same resistance value, have variations when the symmetry of R1, R2, R3 and R4 in the above noted expression (13) is focused. Therefore a variation of the amplification ratio is suppressed.

The amplification circuit of FIG. 5A is configured to use resistors as elements determining the amplification ratio of a non-inverting amplifier has an advantage of simplifying an operation control of the circuit because an initialization process is not required as described above, although the power consumption is increased by an occurrence of a feed-through current as compared to the amplification circuit shown by FIG. 3A and an occupation area size of the circuit on the semiconductor printed circuit board is enlarged in the case of configuring it as an integrated circuit.

Note that the variations of the capacitors C1C, C2C, C3C and C4C, which are so formed as to have the same capacitance value, cause a very little influence on the effect of suppressing a variation of the amplification ratio of the amplification circuit shown by FIG. 5A, also in the amplification circuit shown by FIG. 5A.

Also, the same as the amplification circuit shown by FIG. 3A, a use of the amplification circuit shown by FIG. 5A for the solid-state image pickup device 10 shown by FIG. 2A or for the solid-state image pickup device 20 shown by FIG. 2B eliminates a necessity of equipping a specific use sample hold capacitor on the ADC 18 or 28.

Furthermore, in the case of using the amplification circuit shown by FIG. 5A for the solid-state image pickup device 10 shown by FIG. 2A or for the solid-state image pickup device 20 shown by FIG. 2B, the control circuit 12 or 22 controls a changeover interval of each switch so as to lengthen the interval, if an optical intensity is low, as compared to a case of the aforementioned optical intensity being high, based on the optical intensity of the received light on the image pickup plane of the pixel array 11 or 21, thereby enabling the solid-state image pickup device 10 or 20 to pick up a bright image of a dark object, in the same manner as the amplification circuit shown by FIG. 3A.

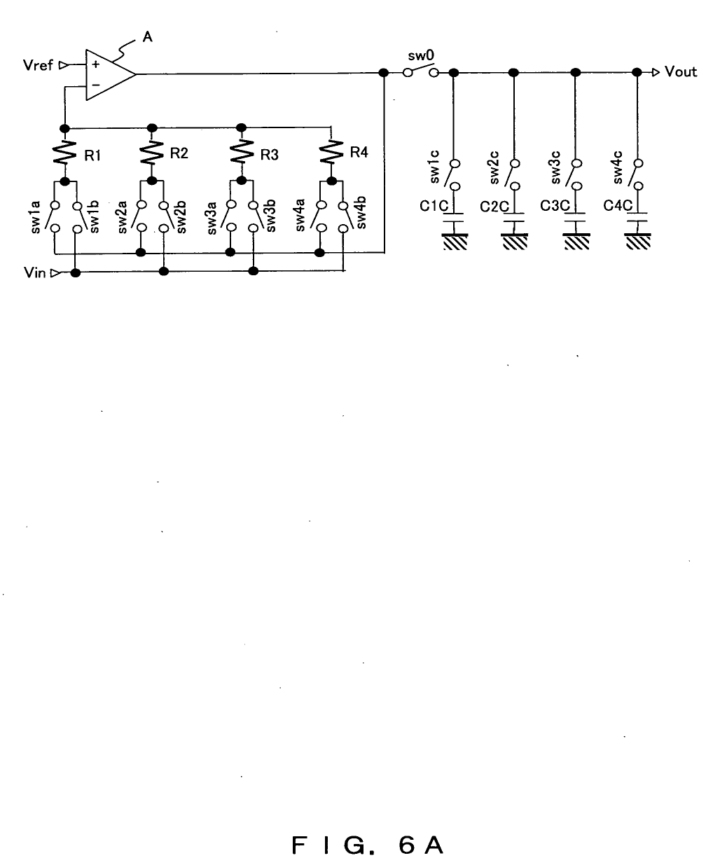

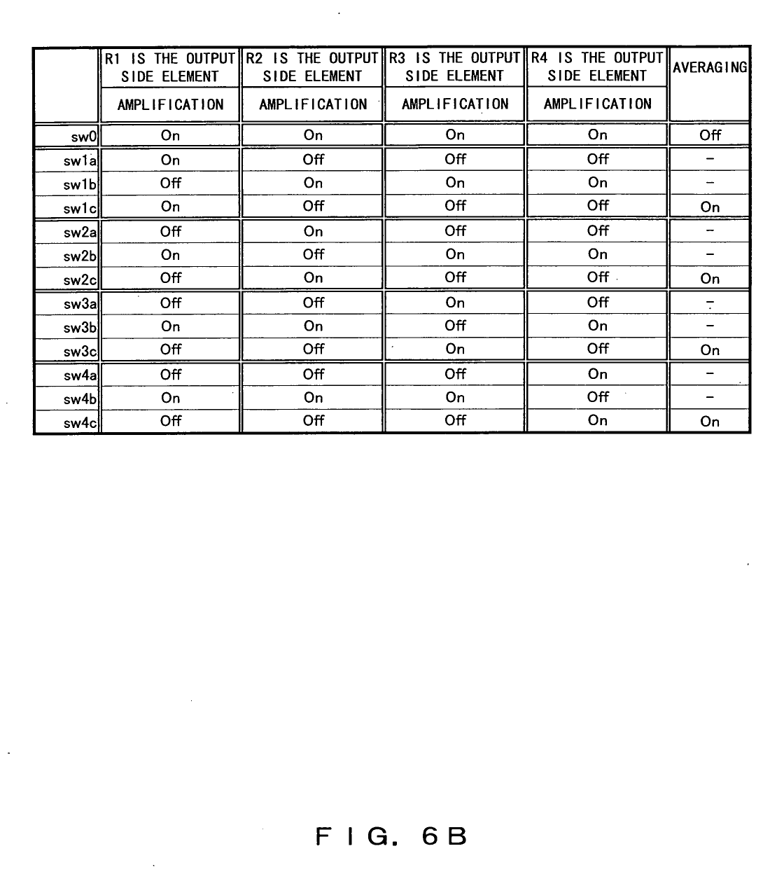

The next description is of FIG. 6A which shows a fourth example of a configuration of an amplification circuit embodying the present invention.

The amplification circuit shown by FIG. 6A comprises an operational amplifier A, resistors R1, R2, R3 and R4, capacitors C1C, C2C, C3C and C4C, switches sw1a, sw1b, sw1c, sw2a, sw2b, sw2c, sw3a, sw3b, sw3c, sw4a, sw4b, sw4c, and sw0. Here, the resistors R1, R2, R3 and R4 are configured to have the same characteristic value (i.e., the resistance value), and so are the capacitors C1C, C2C, C3C and C4C configured to have the same capacitance value.

The amplification circuit shown by FIG. 6A is configured in the same manner as the amplification circuit shown by FIG. 4A except for replacing the capacitors C1, C2, C3 and C4 with the resistors R1, R2, R3 and R4, eliminating the switch swra, which is a dual circuit interlock switch, by making both circuits the state of normal open and eliminating the switch swrb by making it the state of being normally shorted.

The next description is of the amplification circuit of FIG. 6A by referring to the table shown by FIG. 6B.

The table of FIG. 6B shows a changeover control operation of each switch used for the amplification circuit shown by FIG. 6A. Note that, if the amplification circuit shown by FIG. 6A is used as the amplification circuit 16 comprised by the solid-state image pickup device 10 shown by FIG. 2A, the control operation is carried out by the control circuit 12, while if it is used as the amplification circuit 26 comprised by the solid-state image pickup device 20 shown by FIG. 2B, the control operation is carried out by the control circuit 22.

Incidentally, the words “On” and “Off” and the sign which are indicated in the respective field of the table shown by FIG. 5B mean the same as ones shown in the table of FIG. 3B.

The table in FIG. 6B is the same as the table in FIG. 4B except for replacing “C1”, “C2”, “C3” and “C4” with “R1”, “R2”, “R3” and “R4”, respectively, and for a column “Initialization” being nonexistent. That is, the circuit of FIG. 6A does not use a capacitor needing an initialization, thus eliminating an initialization process which is required for the circuit shown by FIG. 4A.

With the exception of not performing an initialization process, the changeover operation for each switch in the circuit of FIG. 6A is the same as in the circuit shown by FIG. 4A. That is, the switches sw1a, sw1b, sw2a, sw2b, sw3a, sw3b, sw4a and sw4b change over the interconnection of the resistors R1, R2, R3 and R4, thereby changing over the organization of the resistors determining an amplification ratio of the inverting amplifier.

The outputs of the operational amplifier A at the time of changing over individual switches are the above noted expressions (8), (9), (10) and (11) with “C1”, “C2”, “C3” and “C4” being replaced by “R1”, “R2”, “R3” and “R4”, respectively. Therefore, the output Vout of the amplification circuit shown by FIG. 6A at the time of controlling for changing over each switch so as to make the state indicated by the word in each field of the column “Averaging” on the right end of the table in FIG. 6B is represented by the following expression if the capacitors C1C, C2C, C3C and C4C have the same capacitance:

$$Vout = - \frac{1}{4} \{ ( R 1 + R 2 + R 3 + R 4 ) ( \frac{1}{R 1} + \frac{1}{R 2} + \frac{1}{R 3} + \frac{1}{R 4} ) - 4 \} Vin \qquad ( 14 )$$

That is, a parallel connection of the capacitors C1C, C2C, C3C and C4C averages out the outputs of the inverting amplifier in this event, which has been obtained at every changeover of the organization of the capacitors.

Here, if R1=R2=R3=R4, the amplification ratio of the amplification circuit is three times according to the above noted expression (14). It is also apparent that the amplification ratio of the amplification circuit of FIG. 6A is averaged out even if the resistance values of the resistors R1, R2, R3 and R4 which are so formed as to have the same resistance value have variations when the symmetry of R1, R2, R3 and R4 in the above noted expression (14) is focused. Therefore a variation of the amplification ratio is suppressed.

The amplification circuit of FIG. 6A is configured to use resistors as elements determining the amplification ratio of an inverting amplifier has an advantage of simplifying an operation control of the circuit because an initialization process is not required as described above, although the power consumption is increased by an occurrence of a feed-through current as compared to the amplification circuit shown by FIG. 3A and an occupation area size of the circuit on the semiconductor printed circuit board is enlarged in the case of configuring it as an integrated circuit.

Note that the variations of the capacitors C1C, C2C, C3C and C4C, which are so formed as to have the same capacitance value, cause a very little influence on the effect of suppressing a variation of the amplification ratio of the amplification circuit shown by FIG. 6A, also in the amplification circuit shown by FIG. 6A.

Also, the same as the amplification circuit shown by FIG. 3A, a use of the amplification circuit shown by FIG. 6A for the solid-state image pickup device 10 shown by FIG. 2A or for the solid-state image pickup device 20 shown by FIG. 2B eliminates a necessity of equipping a specific use sample hold capacitor on the ADC 18 or 28.

Furthermore, in the case of using the amplification circuit shown by FIG. 6A for the solid-state image pickup device 10 shown by FIG. 2A or for the solid-state image pickup device 20 shown by FIG. 2B, the control circuit 12 or 22 controls a changeover interval of each switch so as to lengthen the interval, if an optical intensity is low, as compared to a case of the aforementioned optical intensity being high, based on the optical intensity of the received light on the image pickup plane of the pixel array 11 or 21, thereby enabling the solid-state image pickup device 10 or 20 to pick up a bright image of a dark object, the same as the amplification circuit shown by FIG. 3A.

As such, the embodiments of the present invention are described. The present invention, however, can be improved or changed variously within the scope thereof, in lieu of being limited to the above described embodiments.

For example, a reverse connection of the common contact and make contact of each switch still allows the similar operation of each amplification circuit in the configuration thereof respectively shown by FIGS. 3A, 4A, 5A and 6A.

What is claimed is:

1. An image pickup apparatus, including:
a photoelectric conversion unit for converting a received light into an electric signal; and
an amplification circuit for amplifying the electric signal, wherein
the amplification circuit includes
a plurality of elements of which a characteristic value is formed as the same value,
an amplifier of which an amplification ratio is determined by a characteristic value of two composite elements constituted by connecting one or more of the elements,
a changeover unit for changing over the element constituting each of the composite elements by changing over a connection between the elements, and
an averaging unit for averaging outputs of the amplifier, which are obtained at every time of changing over the elements and making the average an output of the amplification circuit.

2. The image pickup apparatus according to claim 1, wherein
said plurality of elements is a capacitor.

3. The image pickup apparatus according to claim 2, further including
an initialization process unit for shorting between terminals of said capacitors for initialization.

4. The image pickup apparatus according to claim 1, wherein
said plurality of elements is a resistor.

5. The image pickup apparatus according to claim 1, wherein
said amplifier is a non-inverting amplifier using an operational amplifier.

6. The image pickup apparatus according to claim 1, wherein
said amplifier is an inverting amplifier using an operational amplifier.

7. The image pickup apparatus according to claim 1, wherein
said averaging unit includes a plurality of capacitors for accumulating outputs of said amplifier.

8. The image pickup apparatus according to claim 7, further including
an initialization process unit for shorting between terminals of said capacitors for initialization.

9. The image pickup apparatus according to claim 7, further including
an analog-digital (AD) converter for converting an output of said amplification circuit into digital data, wherein
said capacitor is a sample hold capacitor for retaining an output of the amplification circuit on an input side of the AD converter for a predefined period of time.

10. The image pickup apparatus according to claim 1, further including
a changeover control unit for controlling an interval of changing over a connection between said elements by said changeover unit based on an intensity of light received at said photoelectric conversion unit.

11. An amplification circuit, including:
a plurality of elements of which a characteristic value is formed as the same value,
an amplifier of which an amplification ratio is determined by a characteristic value of two composite elements constituted by connecting one or more of the elements,
a changeover unit for changing over the element constituting each of the composite elements by changing over a connection between the elements, and
an averaging unit for averaging outputs of the amplifier which are obtained at every time of changing over the elements.

12. The amplification circuit according to claim 11, wherein
said plurality of elements is a capacitor.

13. The amplification circuit according to claim 12, further including
an initialization process unit for shorting between terminals of said capacitors for initialization.

14. The amplification circuit according to claim 11, wherein
said plurality of elements is a resistor.

15. The amplification circuit according to claim 11, wherein
said amplifier is a non-inverting amplifier using an operational amplifier.

16. The amplification circuit according to claim 11, wherein
said amplifier is an inverting amplifier using an operational amplifier.

17. The amplification circuit according to claim 11, wherein
said averaging unit includes a plurality of capacitors for accumulating outputs of said amplifier.

18. The amplification circuit according to claim 17, further including
an initialization process unit for shorting between terminals of said capacitors for initialization.
